(19) United States
(12) Patent Application Publication
(10) Pub. No.: US 2006/0175447 A1
(43) Pub. Date: Aug. 10, 2006

(54) Cup and cone feed distributor

(76) Inventor: Rodney Dean Duggan, Waxahachie, TX (US)

Correspondence Address: Michael A. O'Neil;Michael A. O'Neil, P.C., Suite 820, 5949 Sherry Lane, Dallas, TX, 75225, US

(21) Appl. No.: 11/054,254

(22) Filed: Feb. 9, 2005

(51) Int. Cl. B02C 7/06

(52) U.S. Cl. 241/261.2

(57) ABSTRACT

A cup and cone feed distributor enables a finer grind of the foodstuffs ground within a grinding chamber, and more efficiently distributes the foodstuffs for engagement with grinding members, preventing accumulation of the foodstuffs at the bottom of the grinding members.

### TECHNICAL FIELD

This invention relates generally to devices for grinding foodstuffs such as grains, nuts, and the like, and more particularly to an apparatus and method for distributing foodstuffs between grinding members and thereby grinding foodstuffs into a finer grind with minimal loss of raw material and minimal equipment down time.

### BACKGROUND AND SUMMARY OF THE INVENTION

Throughout human history, foodstuffs such as grains, nuts, and the like have been ground into meal and flour by means of grinding stones. Traditional systems for grinding foodstuffs comprise a grinding chamber having two grinding plates positioned relative to one another, with the foodstuff to be ground propelled into the grinding chamber by an auger. Once the foodstuff enters the grinding chamber, it must be distributed radially outward between the grinding plates.

Referring to FIGS. 1 through 4 of the drawings, there is shown the grinding chamber 28 of U.S. Pat. Nos. 6,322,013, 6,209,813, and 5,927,628. Within the chamber 28 is a fixed grinding member 50 and a driven grinding member 40. The foodstuffs to be ground are propelled into the grinding chamber 28 by an auger 164. A distributing blade 184, secured to the driven grinding member, distributes the foodstuffs radially outward to be ground between the fixed grinding member 50 and the driven grinding member 40. The foodstuffs are distributed outward between the grinding members 40 and 50 at an angle substantially perpendicular to the rotation of the driven grinding member 40.

Foodstuffs are successfully ground using the distributing blade 184 configuration of the prior art, but only to a course grind. If a finer grind is an additional grinding process has been required. Also, the distributing blade 184 does not distribute the foodstuffs outwardly in the most efficient manner. Instead, the foodstuffs accumulate at the center of the driven grinding member 40 on the distributing blade 184 and become gelatinous lumps. When this occurs, the grinding chamber 28 must be opened and cleaned, slowing down production and necessitating the service of an operator and/or a repair technician.

The present invention comprises a food grinding apparatus and method which overcomes the foregoing and other difficulties which have long since characterized the prior art. In accordance with the broader aspects of the invention a grinding apparatus which improves upon and may be used in conjunction with the cited prior art comprises a cup and cone feed distribution apparatus and method which achieves a finer grind than has heretofore been possible by pre-grinding the foodstuffs and which radially distributes the foodstuffs in a manner that minimizes raw material loss and equipment downtime.

In accordance with the more specific aspects of the invention a cone mounted onto a driven grinding member distributes foodstuffs radially outward for engagement between driven and fixed grinding members in a direction substantially parallel to vanes of the driven grinding member. A cup mounted onto the fixed grinding member facilitates even better foodstuff. Spiral blades comprising the cup and spiral blades comprising the cone facilitate distribution of the foodstuffs in a direction substantially similar to the rotation of the driven grinding member, preventing accumulations of foodstuff at the center of the grinding members, thereby reducing equipment downtime needed for cleaning and maintenance required, and facilitating better yield from the raw foodstuffs.

In addition to improved distribution of the foodstuffs within the grinding chamber, the cup and cone are proximally positioned relative to one another in a manner that provides a pre-grind of foodstuffs. Pre-grinding enables the grinding members to grind the foodstuffs more finely. In addition to facilitating a finer grind, the pre-grinding performed by the cup and cone relieve some of the workload of the grinding members and thus prolongs the useful life of the grinding members.

### BRIEF DESCRIPTION OF THE DRAWINGS

A more complete understanding of the present invention may be had by reference to the following Detailed Description when taken in connection with the accompanying Drawings, wherein:

FIG. 1 is an illustration of a prior art grinding chamber;

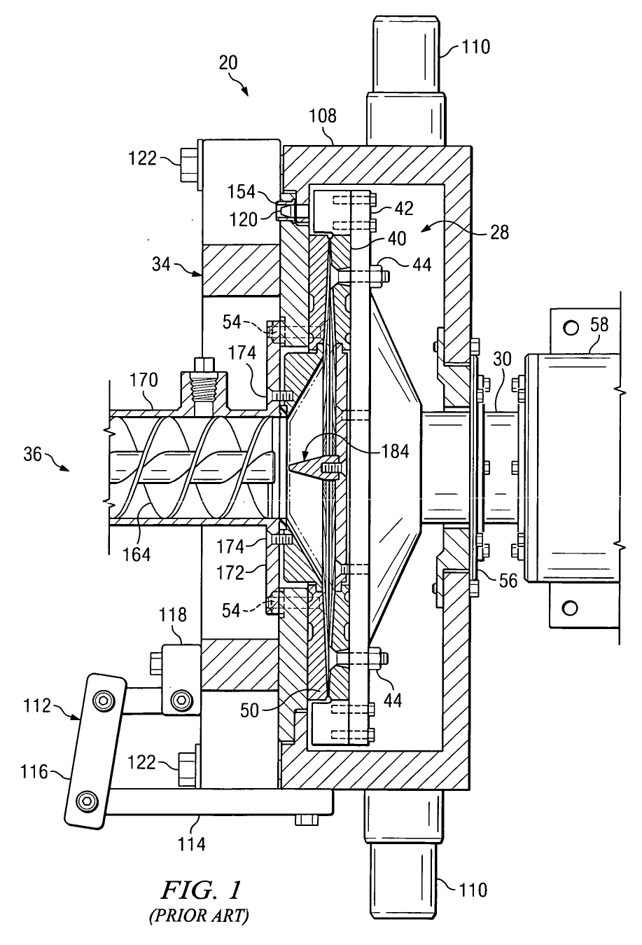

FIG. 2 is an enlarged view of a portion of the grinding chamber shown in FIG. 1;

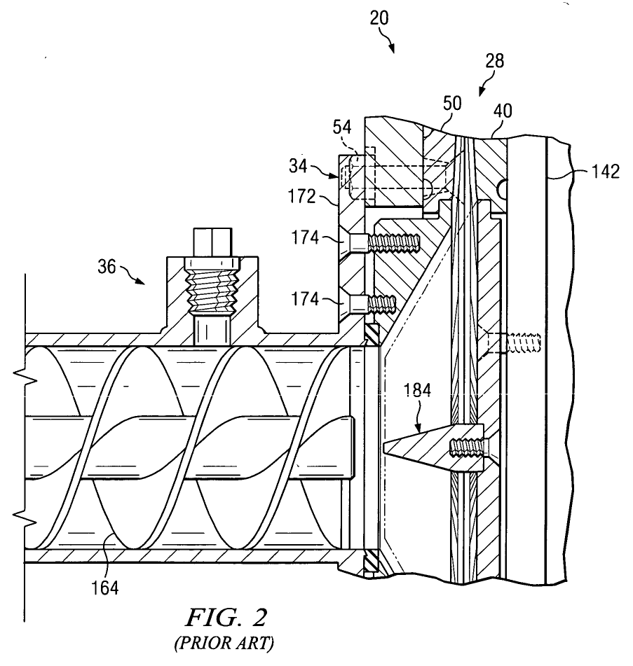

FIG. 3 is a view of a grinding apparatus used in the grinding chamber shown in FIG. 1;

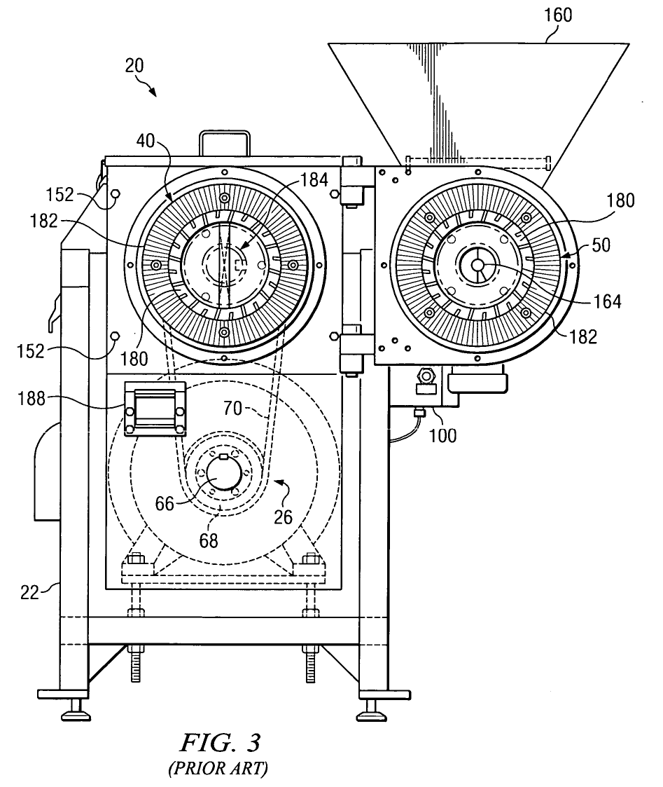

FIG. 4 is an enlarged view of a portion of the grinding apparatus shown in FIG. 3.

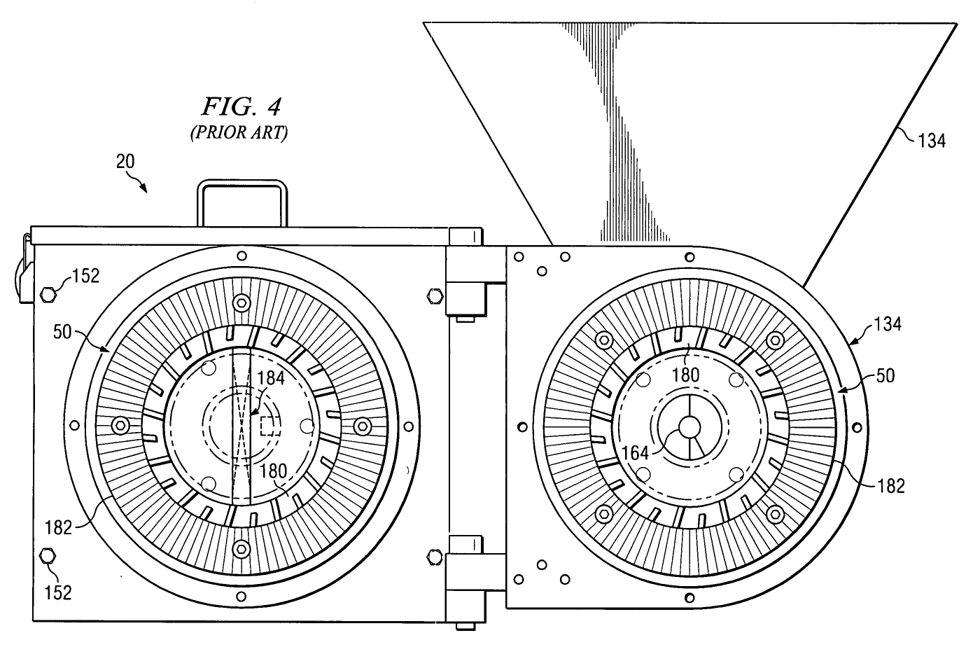

FIG. 5 is a perspective view illustrating one embodiment of the present invention;

FIG. 6 is an enlarged view of the embodiment shown in FIG. 5;

FIG. 7 is a view of a grinding apparatus for grinding foodstuffs comprising the embodiment shown in FIG. 5;

FIG. 8 is an enlarged view of a portion of the embodiment shown in FIG. 7.

FIG. 9 is an enlarged perspective view illustrating an alternate embodiment of the present invention; and

FIG. 10 is a view of a grinding apparatus for grinding foodstuffs comprising the embodiment shown in FIG. 9.

### DETAILED DESCRIPTION

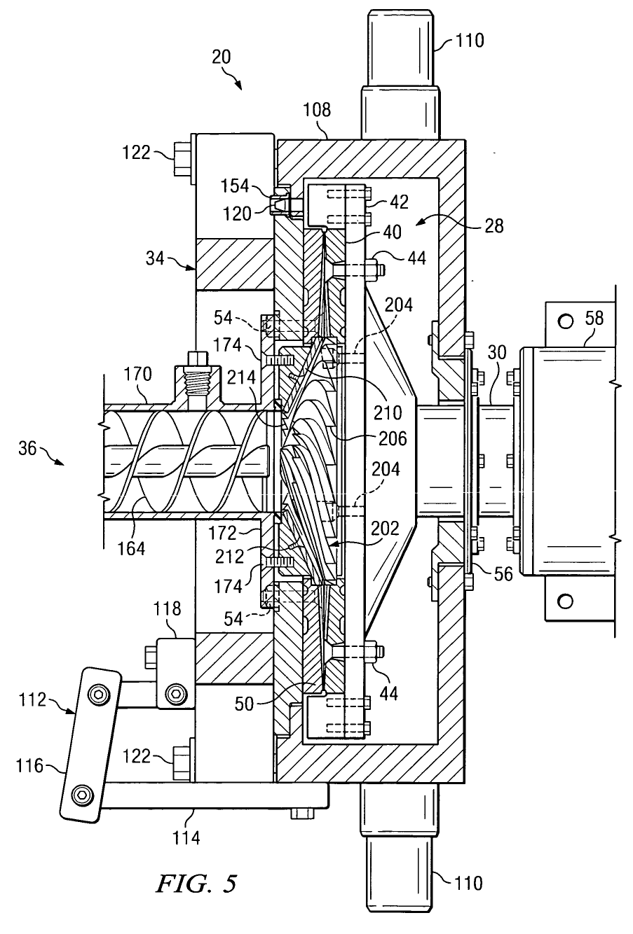

Referring specifically to FIGS. 5 through 8, there is shown the grinding chamber 28 comprising a first embodiment of the present invention which improves upon and may be used in conjunction with the grinding apparatus 20 shown in U.S. Pat. Nos. 6,322,013, 6,209,813, and 5,927,628 and described in detail therein.

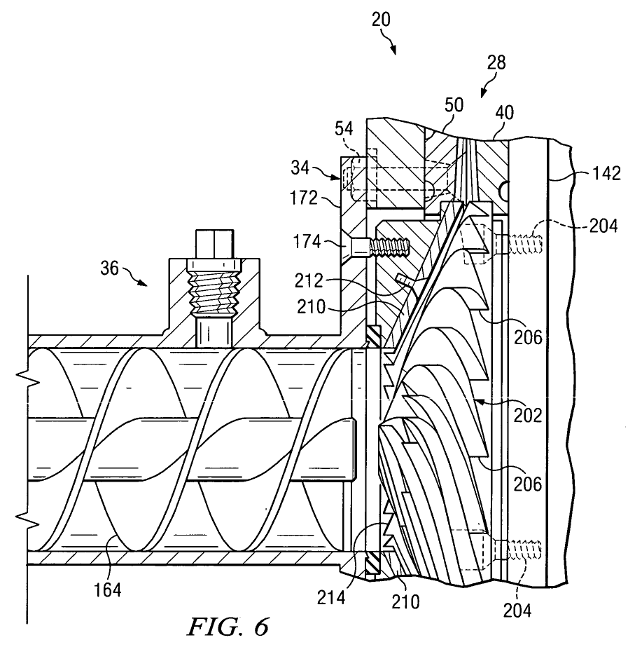

Referring specifically to FIGS. 5 and 6, the grinding chamber 28 comprises a driven grinding member 40 and a fixed grinding member 50, as described in the aforementioned patents. A cone 202 for distributing foodstuff radially outward for engagement between the grinding members 40 and 50 is secured in the center of the driven grinding member 40 by fasteners 204 such that the cone 202 rotates with the driven grinding member 40. The cone 202 may be formed from a metal having a Rockwell C hardness of 30 or greater, or may be formed from other rigid materials known to those skilled in the art and suitable for use in the food processing industry. The cone 202 has spiral fins 206 that extend from the top of the cone 202 to the base of the cone 202, where the cone 202 mates with the driven grinding member 40. As the foodstuff is propelled in the grinding chamber 28 onto the cone 202 by the auger 164, the spiral fins 206 propel the received foodstuff radially outward for engagement between the grinding members 40 and 50 in a direction substantially parallel to the vanes 180 of the driven grinding member 40.

A concave cup 210 is mounted on the fixed grinding member 50 and is secured with fasteners 212. The cup 210 is equipped with spiral fins 214 that extend from the top of the cup 210 to the bottom of the cup 210. The cup 210 and cone 202 are proximally located to each other. The close spatial relationship between the cup 210 and cone 202 facilitates pre-grinding of received foodstuff by the fins 214 of the cup 210 and the fins 206 of the cone 202 as the foodstuff is propelled radially outward. In addition to the cup 210 and cone 202 providing a pre-grind of the foodstuff, other components of the grinding apparatus 20 such as the auger 164 may be configured for pre-grinding of the foodstuff.

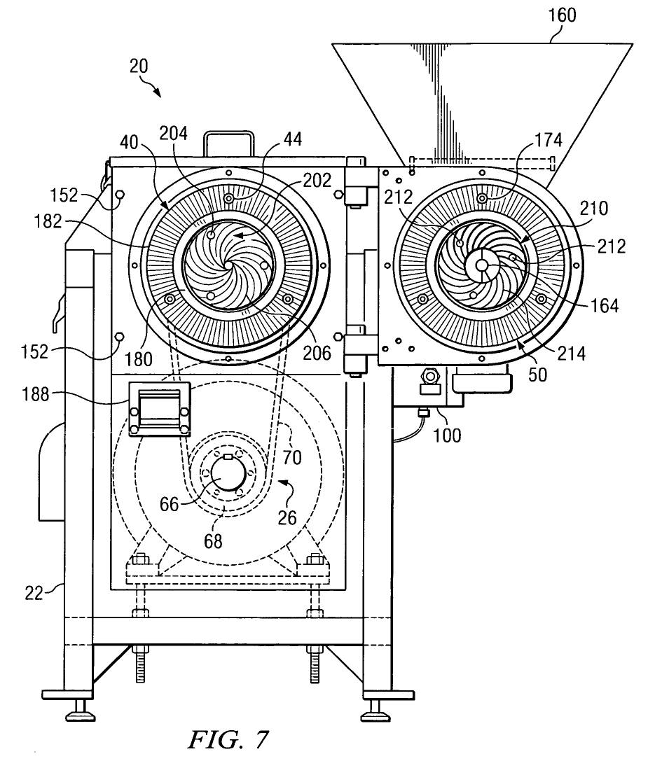

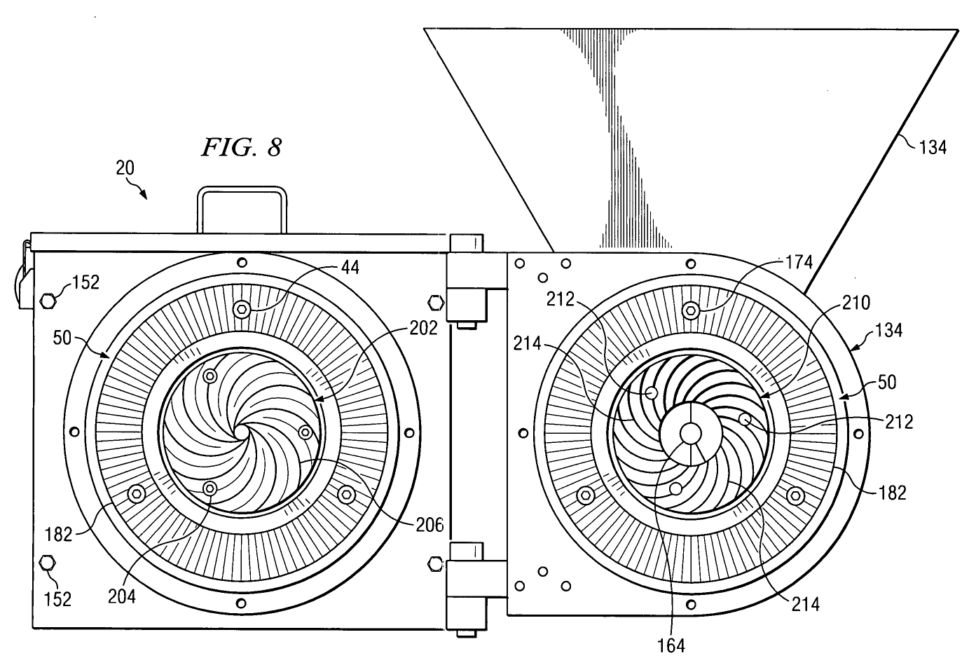

FIGS. 7 and 8 further illustrate the construction and orientation of the grinding chamber 28 as is it is mounted in a grinding apparatus 20.

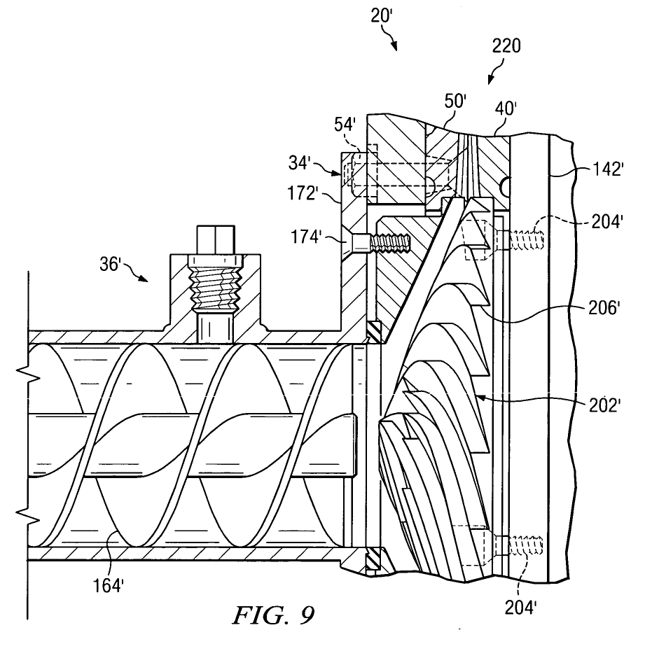

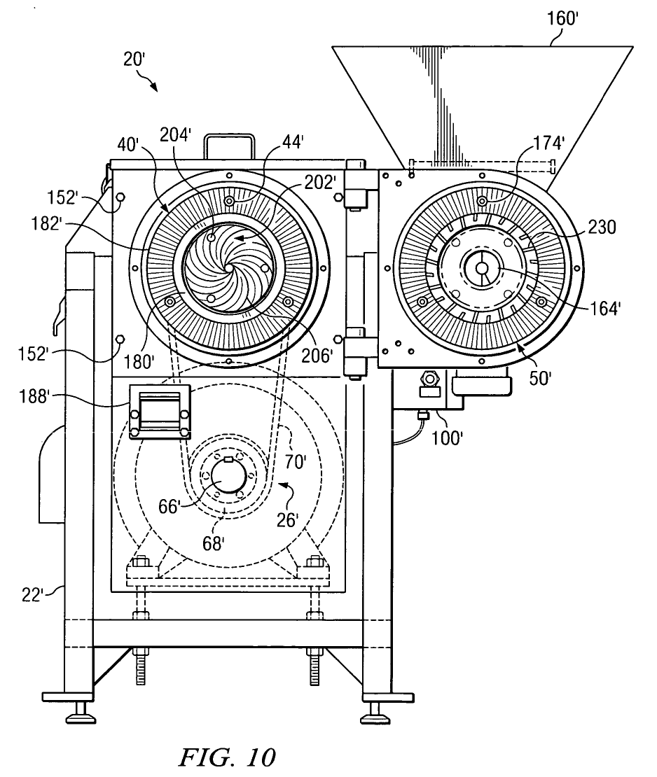

Referring specifically to FIGS. 9 and 10, there is shown a grinding chamber 220 comprising a second embodiment of the invention. Many of the component parts are substantially identical in construction and function to component parts of the embodiment illustrated in FIGS. 5 through 8 and described hereinabove in conjunction therewith. Such identical component parts are designated in FIGS. 9 and 10 with the same reference numerals utilized above in the description of the first embodiment, but are differentiated therefrom by means of a prime (′) designation.

The second embodiment is more suited for applications utilizing a smaller size grinding apparatus 20′. The second embodiment differs from the first embodiment in that there is no concave cup mounted on the fixed grinding member 50′. Rather, the fixed grinding member 50′ is equipped with radial fins 230 which protrude from the fixed grinding member 50′ near the center thereof. The cone 202′ protrudes toward the fixed grinding member 50′ in a manner such that the cone 202′ is proximally positioned relative to the radial fins 230 in a manner that facilitates improved distribution of the foodstuffs and enables a pre-grind of the foodstuffs.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A grinding apparatus for grinding foodstuffs comprising:
a housing;
a first grinding member fixedly mounted within the housing;
a second grinding member mounted within the housing for rotation relative to the first grinding member to grind foodstuffs therebetween;
a cone fixedly mounted in the center of the second grinding member for distributing the foodstuffs radially outward therefrom; and
a cup fixedly mounted in the center of the first grinding member for guiding foodstuffs entering the housing onto the cone.

2. The grinding apparatus for grinding foodstuffs according to claim 1 wherein the cup and cone are proximally located such that the foodstuffs are pre-ground as they travel radially outward therebetween.

3. The grinding apparatus for grinding foodstuffs according to claim 1 wherein the cone comprises a plurality of spiral fins that protrude from the top of the cone to the bottom of the cone where the cone mates with the second grinding member.

4. The grinding apparatus for grinding foodstuffs according to claim 1 wherein the cup comprises a plurality of spiral fins that protrude from the top of the cup to the bottom of the cup where the cup mates with the first grinding member.

5. A grinding apparatus for grinding foodstuffs comprising:
a housing;
a first grinding member fixedly mounted within the housing;
a second grinding member mounted within the housing for rotation relative to the first grinding member to grind foodstuffs therebetween;
means for distributing the foodstuffs radially outward for engagement between the first grinding member and the second grinding member; and
means for pre-grinding of the foodstuffs.

6. The grinding apparatus for grinding foodstuffs according to claim 5 wherein the means for distributing the foodstuffs is a cup mounted on the first grinding member and a cone mounted on the second grinding member such that the cup an cone are proximally located relative to each other.

7. The grinding apparatus for grinding foodstuffs according to claim 5 wherein the means for pre-grinding the foodstuffs is a cup mounted on the first grinding member and a cone mounted on the second grinding member such that the cup an cone are proximally located relative to each other.

8. A method for grinding foodstuffs comprising the steps of:
providing a housing;
propelling foodstuffs into the housing for grinding;
providing a first grinding member fixedly mounted within the housing;
providing a second grinding member mounted within the housing for rotation relative to the first grinding member;
utilizing the first grinding member and second grinding member for grinding foodstuffs therebetween;
providing a cone fixedly mounted in the center of the second grinding member;
utilizing the cone for distributing foodstuffs radially outward for engagement between the first grinding member and the second grinding member; and
utilizing the cone for pre-grinding of foodstuffs as the foodstuffs are distributed radially outward.

9. The method for grinding foodstuffs according to claim 8 including the additional step of pre-grinding foodstuffs as they are propelled into the housing.

10. A method for grinding foodstuffs comprising the steps of:
providing a housing;
propelling foodstuffs into the housing for grinding;
providing a first grinding member fixedly mounted within the housing;
providing a second grinding member mounted within the housing for rotation relative to the first grinding member;
utilizing the first grinding member and second grinding member for grinding foodstuffs therebetween;
providing a cone fixedly mounted in the center of the second grinding member;
providing a cup fixedly mounted in the center of the first grinding member;
utilizing the cone and the cup for distributing foodstuffs radially outward for engagement between the first grinding member and the second grinding member; and
utilizing the cone and the cup for pre-grinding of foodstuffs as the foodstuffs are distributed radially outward.

11. The method for grinding foodstuffs according to claim 10 including the additional step of pre-grinding foodstuffs as they are propelled into the housing.
